(19) United States
(12) Patent Application Publication
(10) Pub. No.: US 2017/0004587 A1
(43) Pub. Date: Jan. 5, 2017

(54) THIRD PARTY ENDORSEMENTS

(71) Applicant: LinkedIn Corporation, Mountain View, CA (US)

(72) Inventors: Michael Christopher Pruett, Los Gatos, CA (US); Dan Shapero, Palo Alto, CA (US); Aleksandr Movsesyan, San Bruno, CA (US)

(21) Appl. No.: 14/788,440

(22) Filed: Jun. 30, 2015

(51) Int. Cl. G06Q 50/00; H04L 29/08; G06F 17/30; H04L 29/06

(52) U.S. Cl. CPC G06Q 50/01; H04L 65/403; H04L 67/306; G06F 17/30864

(57) ABSTRACT

System and techniques for third party endorsement are described herein. An indication that includes an attribute to identify a second entity and a skill for the second entity may be received from a first entity in a social networking service, the second entity being outside a social graph of the first entity. A member profile for the second entity may be obtained by comparing the indication to attributes in a set of member profiles. A first attribute may be added to the skill in the member profile including the identity of the first entity.

### TECHNICAL FIELD

Embodiments described herein generally relate to social networking services and more specifically to third party endorsements in a social networking service.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of an example of an environment including a social networking service including a third party endorsement system, according to an embodiment.

FIG. 2 illustrates a block diagram of an example of a user profile for third party endorsements, according to an embodiment.

FIG. 3 illustrates a flowchart of an example workflow for third party endorsements, according to an embodiment.

FIG. 4 illustrates an example of a method for third party endorsements, according to an embodiment.

FIG. 5 is a block diagram illustrating an example of a machine upon which one or more embodiments may be implemented.

### DETAILED DESCRIPTION

Social networking services may allow users to establish a user profile containing self-provided personal or professional information. The user's profile information, or subsets thereof, may be shared with other users of the social networking service. Some of the information in a user's profile may pertain to professional skills that have been obtained through education and work experience. Other users may wish to use this information when looking for individuals to fill a role having a particular skill set (e.g., to fill a job vacancy). However, because the skills may be self-provided, there may be a weak corroboration between the user's profile and the skill because there may not be independent evidence that the skill was obtained. A third party endorsement may be an endorsement provided by an entity outside the social graph of a member or potential member of a social networking service (e.g., an entity that is not a first degree connection of the member or potential member). For example, an educational institution or entity may endorse a student for a skill. Educational entities may wish to highlight the services they provide by providing endorsements for students that are members of a social networking service. The educational entities may also wish to add value for students by lending credibility to the skill listed in the students' social networking profile. However, current skills endorsements may lack the functionality to enable an educational entity outside a student's social graph to add skill attributes to the student's profile. The educational entity could request to be added to the social graph of each student, but this may be time-consuming and tedious. In some scenarios, the educational entity may wish to provide endorsements in bulk (e.g., for an entire class, etc.). Without adequate verification, someone other than the educational entity may fraudulently add attributes to a profile of a member of the social networking service.

Providing a platform for third party endorsements may include receiving from a first entity (e.g., a third party such as an educational institution) an indication of a second entity (e.g., a student) and a skill achieved (e.g., intro to Java). In addition, the indication may include evidence that the skill was achieved (e.g., a link to source code, a passing score in an introduction to Java course, etc.). The indication may then be matched to a user profile. If a profile match is not located on the social network, then a notification may be sent to the second entity including the identity of the educational entity and the skill achieved. The notification may allow the second entity to create a profile on the social networking service if one does not exist or provide credentials to allow the attributes (e.g., the identity of the educational entity, the evidence of skill achievement, etc.) to be added to the profile. If a profile match exists, the skill achieved may be matched to a skill in the second entity's profile. If the skill does not exist in the second entity's profile, a notification may be provided to the second entity that may allow the skill to be added to the profile. If the skill exists in the second entity's profile, skill attributes may be added to the skill without communicating with the second entity.

The addition of skill attributes reflecting verified third party endorsements may provide corroboration of the skills in the second entity's profile. The skill attributes displayed in the second entity's profile may also be seen by others viewing the second entity's profile (e.g., connections, potential employers, etc.) which may demonstrate to the second entity the value provided by the educational entity and may demonstrate to the others viewing the profile the skills that can be achieved through the educational entity. In addition, credibility and integrity may be achieved through the multi-step verification process of adding attributes to the skill of the second entity.

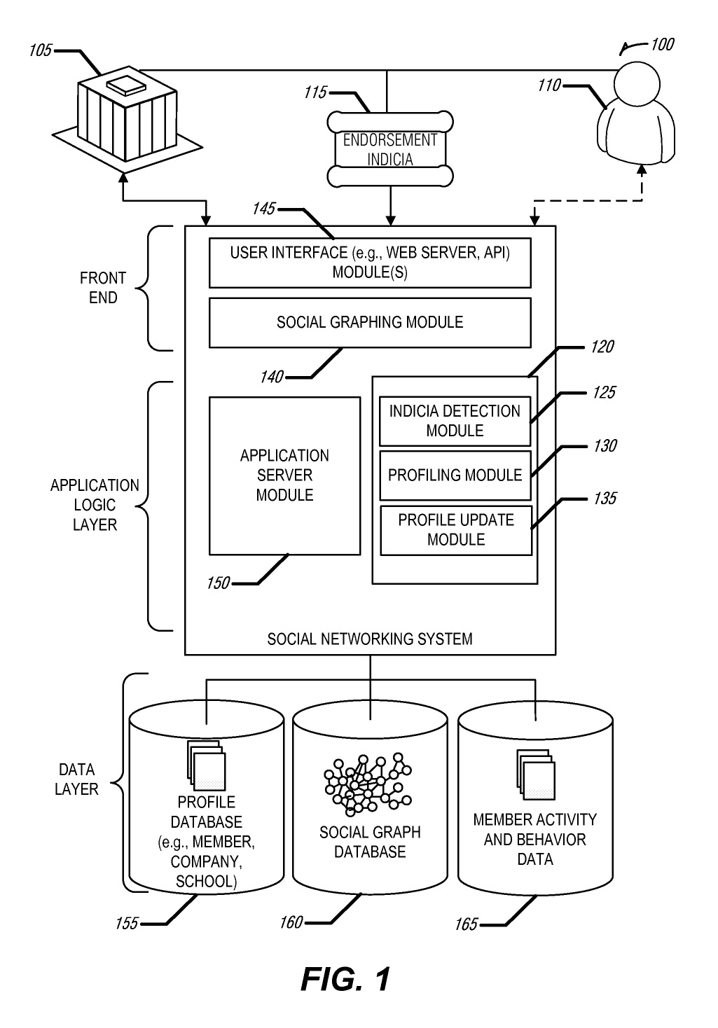

FIG. 1 illustrates a block diagram of an example of an environment including a social networking service 100 including a third party endorsement system 120, according to an embodiment. The social networking service 100 may be hosting the third party endorsement system 120. The environment may include a first entity 105 (e.g., an educational entity, etc.), a second entity 110 (e.g., a student of the educational entity, etc.), and endorsement indicia 115 (e.g., identity of the first and second entities 105, 110, a skill attained, evidence of skill attainment, etc.). The third party endorsement system 120 may include an indicia detection module 125, a profiling module 130, a profile update module 135. The third party endorsement system 120 may make use of profile database 155, social graph database 160, and member activity and behavior data 165 while in operation. The interfaces for the third party endorsement system 120 may be provided by user interface module(s) 145 (e.g., a web server, application programming interface (API), etc.).

As shown in FIG. 1, a front end module may comprise a user interface module (e.g., a web server) 145, which receives requests from various client-computing devices, and communicates appropriate responses to the requesting client devices. For example, the user interface module(s) 145 may receive requests in the form of Hypertext Transport Protocol (HTTP) requests, or other network-based, application programming interface (API) requests (e.g., from a dedicated social networking service application running on a client device). In addition, a social graphing module 140 may be provided to determine the social graph of members and determine the connections that exist between various members of the social networking system. As shown in FIG. 1, the social graphing module 140 may use social graph data corresponding to members of the social networking system stored in a social graph database 160 to determine connections between members.

An application logic layer may include one or more various application server modules 150, which, in conjunction with the user interface module(s) 145, generate various graphical user interfaces (e.g., web pages) with data retrieved from various data sources in the data layer. With some embodiments, application server module 150 is used to implement the functionality associated with various applications and/or services provided by the social networking service 100 as discussed herein.

The application logic layer may also include the third party endorsement system 120 including the indicia detection module 125 which, in conjunction with application server module 150, user interface modules 145, profiling module 130, and profile update module 135, provide the ability to allow third party endorsement of members and the like via one or more user interfaces provided by user interface module(s) 145 to users of the social networking service 100. In some examples, the second entity 110 is outside a social graph (e.g., not a 1^{st} degree connection, not a friend, etc.) of the first entity 105. In some other examples, the second entity 110 is inside a social graph of the first entity 105. In yet other examples, the second entity 110 is not a member of the social networking service 100. The first entity 105 submits the endorsement indicia 115 via the user interface module(s) 145 (e.g., via API, web user interface, etc.). For example, Internet State University may submit an endorsement upon John Smith's completion of an Introduction to Java course provided by Internet State University. The user interface module(s) 145 passes the endorsement indicia 115 to the indicia detection module 125. The indicia detection module 125 receives, from the first entity 105 in a social networking service 100, the endorsement indicia 115 or indication that includes an attribute to identify the second entity 110 and a skill for the second entity 110. The indication may also include evidence the skill was attained by the second entity 110. The indicia detection module 125 then passes the indicia to the profiling module 130.

The profiling module 130 may locate matching member profiles and skills corresponding with each of the user profiles based on the indicia obtained from the indicia detection module 125. If the profiling module 130 does not locate a member profile in the social networking service 100, a notification may be sent to the second entity 110 to create a member profile and may include the indicia. The profiling module 130 obtains a member profile for the second entity 110 by comparing the indication to attributes in a set of member profiles. For example, the endorsement indicia 115 may include John Smith's email address, john.smith@smithco.com, and the email address is compared to member profiles of the social networking service 100 to find John Smith's member profile. Other attributes used to find a member profile may include a name, a member profile identifier, and other identifying attributes in the member profile.

In an example, the profiling module 130 may communicate to the second entity 110, when the set of member profiles does not include the attribute to identify the second entity 110, an invitation to create a new member profile. For example, John Smith may be sent an invitation via email to create a profile on the social networking service 100 if the email address john.smith@smithco.com does not match any profile of the social networking service 100. The invitation may include, for example, attributes identified by the indicia detection module 125 from the endorsement indicia 115 such as the identity of Internet State University, a skill—intro to Java—attained, and Java source code created by John Smith as evidence of skill attainment. The profiling module 130 may then select, in response to creation of the new member profile, the new member profile as the member profile. For example, when John Smith creates a member profile on the social networking service 100, his newly created member profile will be selected. In an example, the invitation includes the skill, and the skill is added to the new member profile upon creation. For example, the invitation may include a message such as “Internet State University would like to endorse you for Intro to Java based on your Java source code . . . login/signup to accept,” and when John Smith's new member profile is created, the skill Intro to Java may be added to the member profile.

In an example, the profiling module 130 may communicate to the second entity 110, when the set of member profiles does not include the attribute to identify the second entity 110, an invitation to sign in using an existing member profile. For example, John Smith may be sent an invitation via email to sign in to a profile he previously created on the social networking service 100 (e.g., a member profile with email address jsmith@smith.com) if the email address john.smith@smithco.com does not match any profile of the social networking service 100. The invitation may include, for example, attributes identified by the indicia detection module 125 from the endorsement indicia 115 such as the identity of Internet State University, a skill—intro to Java—attained, and Java source code created by John Smith as evidence of skill attainment. The profiling module 130 may then select, in response to signing into the existing member profile, the existing member profile as the member profile. For example, when John Smith signs into the member profile he previously created on the social networking service 100, his existing member profile will be selected. In an example, the invitation includes the skill, and the skill is added to the existing member profile upon sign in. For example, the invitation may include a message such as “Internet State University would like to endorse you for Intro to Java based on your Java source code . . . login/signup to accept,” and when John Smith signs into using his existing member profile, the skill Intro to Java may be added to the existing member profile. In an example, the attribute to identify the second entity 110 may be added to the existing member profile upon signing in using the existing member profile.

In an example, the profiling module 130 may calculate a profile match score based on the comparing the indication to attributes in the set of member profiles. It will be understood that many pattern-matching algorithms (e.g., Knuth-Morris-Pratt, Boyer and Moore, Karp and Rabin, etc.) may be used to generate the profile match score. The profiling module 130 may then select the member profile from the set of member profiles based on the profile match score. In an example, the identity of the second entity 110 in the endorsement indicia 115 may be pattern-matched to the attributes (e.g., email addresses, names, etc.) in the set of member profiles to generate the profile match score. For example, Internet State University may send an endorsement message including John Smith's email address john.smith@smithco.com and a member profile having the email address john.smith@smithcorp.com may be selected as having the highest profile match score. Other examples of attributes that may be used for pattern matching may include name, member identifier, and other identifying attributes of the member profile. The profile-match score may be based on a one-to-one, one-to-many, or many-to-many pattern match of attributes of the second entity 110 in the endorsement indicia 115 to attributes in the set of member profiles. For example, John Smith's name and date of birth, 1/28/1972, in the endorsement message from Internet State University may be matched to a member profile including J. Smith with the birth date information including 1/28/1972.

The profile update module 135 may add one or more attributes to a skill corresponding to the member profile located by the profiling module 130. The corresponding skills may be added to the member profile and stored in profile database 155. The profile update module 135 may send a notification to the member if the skill indication does not match a skill corresponding to the member's profile. Upon user acceptance of the skill addition, the attribute may be added to the skill corresponding with the member's profile.

The profile update module 135 may add a first attribute to the skill in the member profile (e.g., the member profile of the second entity 110) including the identity of the first entity 105. For example, the endorsement indicia 115 may include the skill intro to Java attained by John Smith by attending a course provided by Internet State University, and the attribute added to the skill may be “Endorsed by Internet State University.”

In an example, the profile update module 135 may communicate, to the second entity 110, an invitation to add the skill to the member profile when the member profile does not include the skill. For example, if the member profile of John Smith does not include the skill intro to Java, John Smith may be sent an email prompt to add the skill intro to Java to his member profile. The profile update module 135 may then create the skill in the member profile triggered by a response to the invitation that includes an indication to add the skill. For example, the skill intro to Java may be added to John Smith's member profile when he accepts the invitation to add the skill to his member profile.

In an example, the profiling module 130 may select the member profile from the set of member profiles and select a skill from a set of skills corresponding to the member profile. For example, John Smith's member profile may exist on the social networking service 100 and may already have the intro to Java skill in his profile; John Smith's member profile and the intro to Java skill may be selected. The profile update module 135 adds the first attribute to the skill without communicating to the second entity 110. For example, an attribute “Endorsed by Internet State University” may be added to the intro to Java skill corresponding to John Smith's member profile without sending any message to John Smith.

In an example, the indication includes skill confirmation data and a second attribute is added to the skill including the skill confirmation data. For example, the endorsement indicia 115 may include the identity of Internet State University, the intro to Java skill attained, and Java source code created by John Smith as skill confirmation data, and the Java source code created by John Smith or a link to the source code may be added as an attribute of the skill intro to Java corresponding to John Smith's member profile. In an example, the second attribute added to the skill may be a skill ranking or score. For example, John Smith may have received a score of 3.5 out of 4.0 in the intro to Java course taken from Internet State University and the second attribute added to the score may be “3.5 out of 4.0 in Intro to Java course.” In an example, the skill confirmation data includes a URL and the second attribute includes content retrieved from the URL. For example, the endorsement indicia 115 may include a uniform resource locator (URL) providing a link to the Java source code created by John Smith, and the source code is retrieved by the profile update module 135 and added as an attribute of the intro to Java skill corresponding to John Smith's member profile. In an example, the second attribute includes a visual indication of the skill confirmation data. For example, the attribute added to the intro to Java skill corresponding to John Smith's member profile may be an icon indicating that corroboration data such as the Java source code written by John Smith is available as evidence of John Smith's attainment of the intro to Java skill.

Consistent with some embodiments, when a person initially registers to become a member of the social networking service 100, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the profile database 155. Similarly, when a representative of an organization initially registers the organization with the social networking service 100, the representative may be prompted to provide certain information about the organization. This information may be stored, for example, in the profile database 155, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects, is stored and maintained within a social graph in the social graph database 160. Also, as members interact with the various applications, services, and content made available via the social networking service 100, the members' interactions and behavior (e.g., content viewed, links or buttons selected, messages responded to, etc.) may be tracked and information concerning the member's activities and behavior may be logged or stored, for example, as indicated in FIG. 1 by the member activity and behavior database 165.

With some embodiments, the social networking service 100 provides an application programming interface (API) module with the user interface module 145 via which applications and services can access various data and services provided or maintained by the social networking service 100. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service 100, other than data privacy concerns, nothing prevents the API from being provided to the public or to certain third parties under special arrangements, thereby making the navigation recommendations available to third party applications and services.

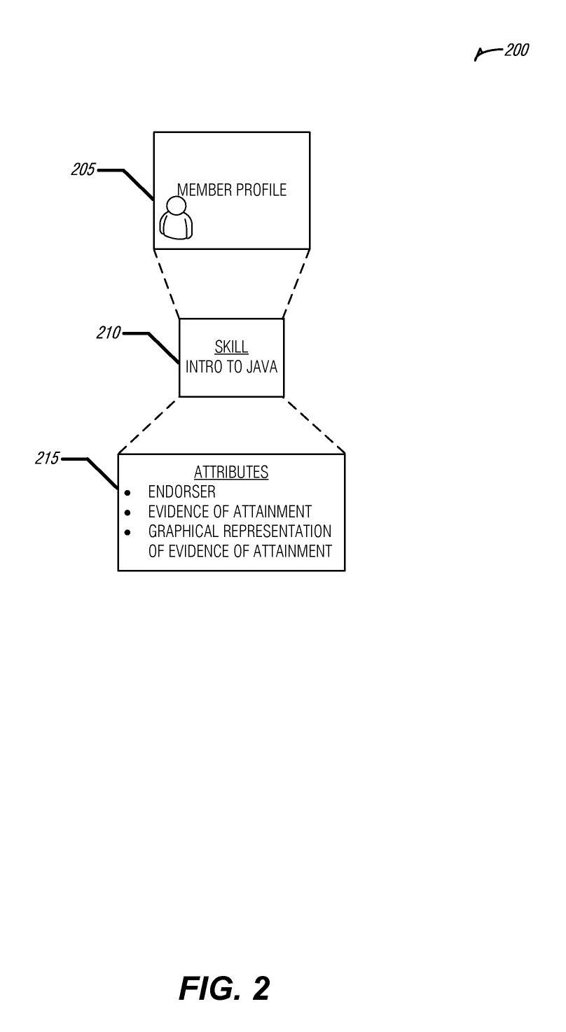

FIG. 2 illustrates a block diagram 200 of an example of a member profile for third party endorsements, according to an embodiment. As described in FIG. 1, attributes may be added to the profile of the second entity 110 which may be a member of the social networking service 100. In an example embodiment, a member profile 205 may exist in a social networking service. The member profile 205 may include a number of corresponding skills such as skill 210 (e.g., intro to Java). Each skill 210 may have corresponding attributes such as the attributes 215. For example, the attributes 215 may include third party endorsement attributes such as those discussed in FIG. 1. For example, the attributes 215 may include a first entity (e.g., an educational entity as endorser), evidence of skill attainment (e.g., data gathered from a URL provided in the endorsement indicia 115 of FIG. 1), and a graphical representation of the evidence of skill attainment (e.g., an icon showing that evidence has been provided for the endorsement). The skill 210 and corresponding attributes 215 may be visible to others viewing the member profile 205. The ability to view the data may be determined by the profile settings of the member profile 205.

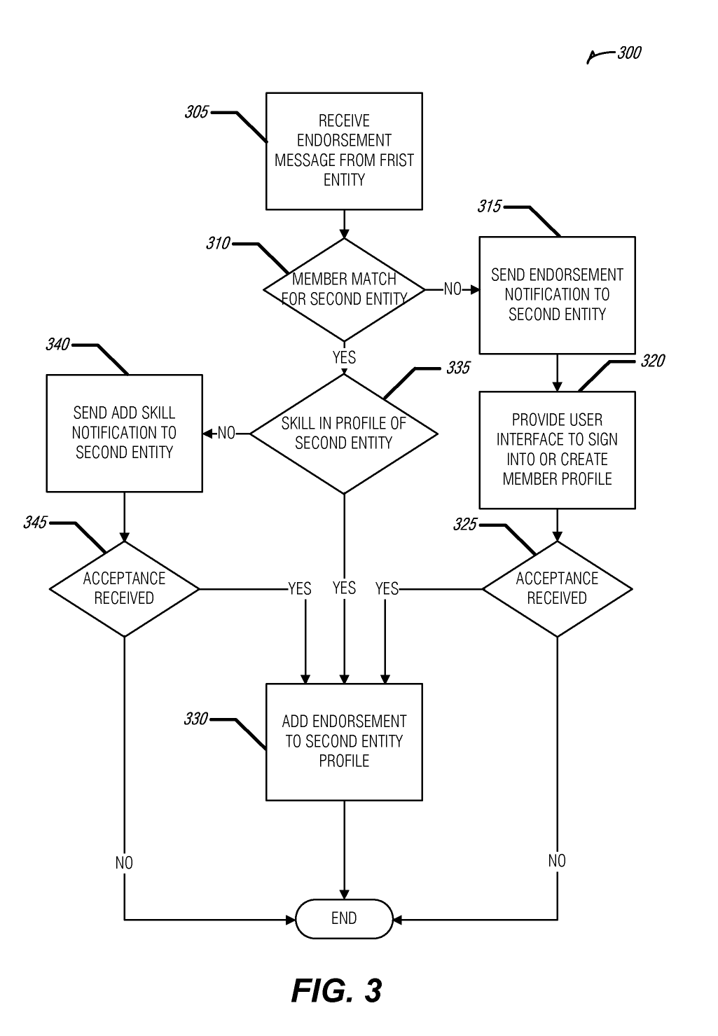

FIG. 3 illustrates a flowchart of an example workflow 300 for third party endorsements, according to an embodiment. As shown in FIG. 3, workflow 300 provides a process for determining when a second entity (e.g., endorsee) may be sent a notification to verify an endorsement by a first entity (e.g., endorser) from the third party endorsement system 120 described in FIG. 1.

At operation 305, the third party endorsement system 120 may receive an endorsement message from a first entity (e.g., via API, a web user interface, etc.). For example, Internet State University may send a message to the third party endorsement system 120 endorsing John Smith for intro to Java. At decision operation 310, the third party endorsement system 120 may determine if there is a member profile match for the second entity. For example, the profiling module 130 of the third party endorsement system 120 may locate a member profile for John Smith. If a match is not found, the process continues to operation 315; if a match is found, the process continues to decision operation 330.

At operation 315, having not found a matching member profile at decision operation 310, the third party endorsement system 120 may send an endorsement notification to the second entity. For example, an email may be sent to John Smith including “Internet State University has endorsed you for Intro to Java based on your Java source code . . . log in/signup.” At operation 320, a user interface is provided to the second entity to sign into an existing member profile or create a new member profile. Upon signing into an existing member profile or creating a new member profile, an acceptance is sent and the process continues at decision operation 325. At decision operation 325, the third party endorsement system 120 determines if an acceptance has been received from the second entity. At operation 330, having determined the acceptance was received at decision operation 325, the endorsement is added to the second entity profile. For example, “Endorsed by Internet State University for intro to Java” may be added to John Smith's member profile.

At decision operation 335, having located a member profile match at decision operation 310, the third party endorsement system 120 determines if a skill included in the endorsement message is in the member profile of the second entity. If the skill is included in the member profile of the second entity, the process continues to operation 330 as described above, and if the skill is not included in the member profile of the second entity, the process continues to operation 335.

At operation 340, the third party endorsement system 120 may send an add skill notification to the second entity. At decision operation 345, the third party endorsement system 120 determines if an acceptance has been received from the second entity. If an acceptance is received by the third party endorsement system 120 at decision operation 345 the process continues to operation 330 as described above.

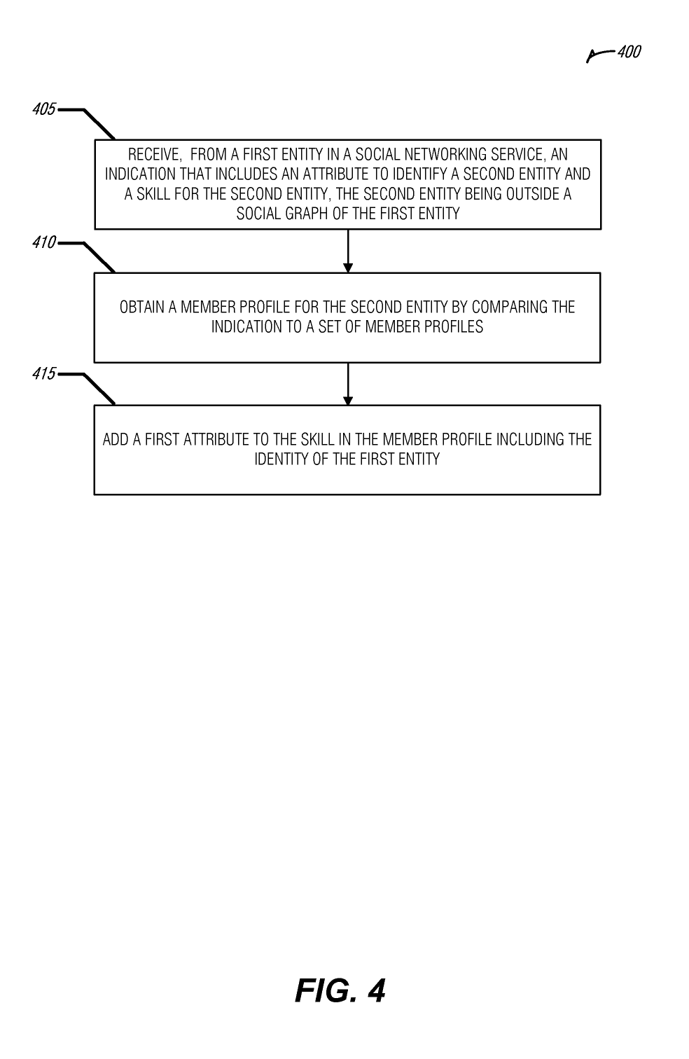

FIG. 4 illustrates an example of a method 400 for third party endorsements, according to an embodiment. The method 400 may be implemented on a system such as the third party endorsement system 120 as described in FIG. 1.

At operation 405, an indication that includes an attribute to identify a second entity and a skill for the second entity may be received from a first entity in a social networking service, the second entity being outside a social graph of the first entity (e.g., the second entity is not a first degree connection of the first entity).

At operation 410, a member profile for the second entity is obtained by comparing the indication to attributes in a set of member profiles. In an example, an invitation to create a new member profile may be sent to the second entity when the set of member profiles does not include the attribute to identify the second entity and the new member profile may be selected as the member profile in response to creation of the new member profile. In an example, the invitation may include the skill, and the skill is added to the new member profile upon creation.

In an example, a profile match score may be calculated based on comparing the indication to the attributes in the set of member profiles, and the member profile may be selected from the set of member profiles based on the profile match score. In an example, the selected member profile may be the member profile having the highest profile match score.

At operation 415, a first attribute may be added to the skill in the member profile including the identity of the first entity. In an example, an invitation to add the skill to the member profile may be communicated to the second entity when the member profile does not include the skill, and the skill is created in the member profile triggered by a response to the invitation that includes an indication to add the skill.

In an example, at operation 410, the member profile may be selected from the set of member profiles and a skill from a set of skills corresponding to the member profile may be selected; at operation 415, the first attribute may be added to the skill without communicating with the second entity.

In an example, the indication may include skill confirmation data and a second attribute may be added to the skill including the skill confirmation data. In an example, the skill confirmation data may include a URL and the second attribute includes content retrieved from the URL. In an example, the second attribute includes a visual indication of the skill confirmation data.

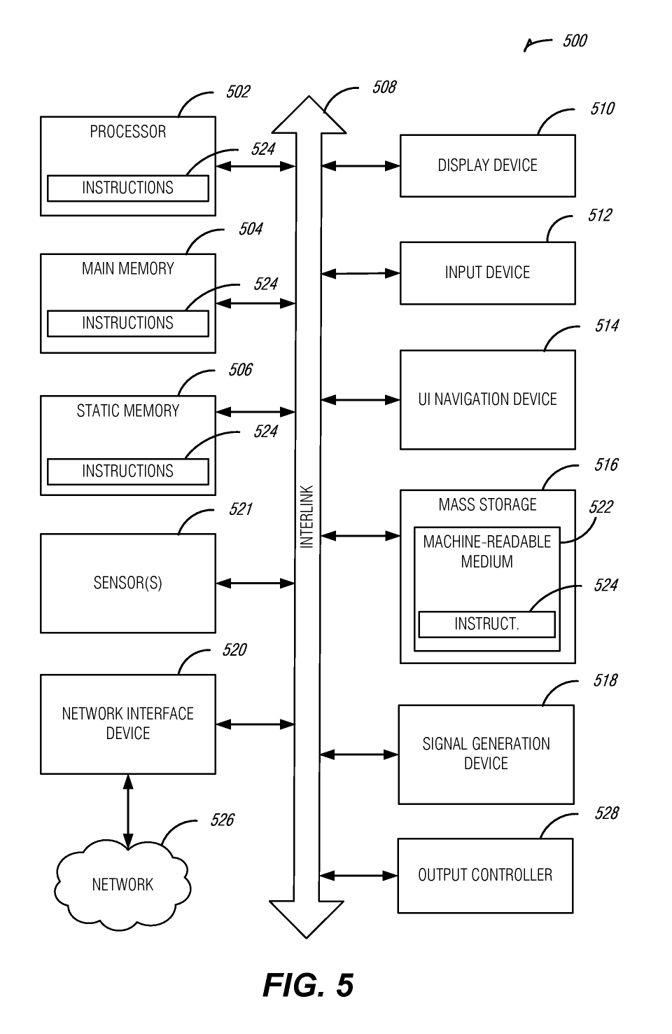

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display device 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a mass storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions (such as instructions 624) for execution by the machine 500, and includes digital or analog communications signals or other intangible medium to facilitate communication of such software.

### ADDITIONAL NOTES & EXAMPLES

Example 1 includes subject matter (such as a device, apparatus, or machine) comprising: at least one processor; a memory; a set of instructions operable on the at least one processor to: receive, from a first entity in a social networking service, an indication that includes an attribute to identify a second entity and a skill for the second entity, the second entity being outside a social graph of the first entity; obtain a member profile for the second entity by comparing information in the indication received from the first entity to attributes in a set of member profiles; and add a first attribute to the skill in the member profile, the first attribute including the identity of the first entity.

In Example 2, the subject matter of Example 1 may include, wherein the set of instructions to obtain the member profile includes instructions to: determine that the set of member profiles does not include the attribute to identify the second entity; responsive to determining that the set of member profiles does not include the attribute to identify the second entity, communicating, to the second entity, an invitation to create a new member profile; and select, in response to creation of the new member profile, the new member profile as the member profile.

In Example 3, the subject matter of any one of Examples 1 to 2 may include, wherein the invitation includes the skill and the skill is added to the new member profile upon creation.

In Example 4, the subject matter of any one of Examples 1 to 3 may include, wherein the set of instructions to obtain the member profile includes instructions to: determine that the set of member profiles does not include the attribute to identify the second entity; responsive to determining that the set of member profiles does not include the attribute to identify the second entity, communicating, to the second entity, an invitation to sign into an existing member profile; and select, in response to signing into the existing member profile, the existing member profile as the member profile.

In Example 5, the subject matter of any one of Examples 1 to 4 may include, wherein the invitation includes the skill and the skill is added to the exiting member profile upon signing into the existing member profile.

In Example 6, the subject matter of any one of Examples 1 to 5 may include, wherein the attribute to identify the second entity is added to the existing member profile upon signing into the existing member profile.

In Example 7, the subject matter of any one of Examples 1 to 6 may include, wherein the set of instructions to add the first attribute includes instructions to: determine that the member profile does not include the skill; responsive to determining that the member profile does not include the skill, communicating, to the second entity, an invitation to add the skill to the member profile; and responsive to receiving an acceptance of the invitation, add the skill to the member profile.

In Example 8, the subject matter of any one of Examples 1 to 7 may include, wherein the set of instructions to obtain the member profile includes: select the member profile from the set of member profiles; and select a skill from a set of skills corresponding to the member profile, and wherein adding the first attribute to the skill does not include communicating with the second entity.

In Example 9, the subject matter of any one of Examples 1 to 8 may include, wherein the set of instructions to obtain the member profile includes: calculate a profile match score based on the comparing the indication to the attributes in the set of member profiles; and select the member profile from the set of member profiles based on the profile match score.

In Example 10, the subject matter of any one of Examples 1 to 9 may include, wherein the indication includes skill confirmation data and a second attribute is added to the skill in the member profile, the second attribute including the skill confirmation data.

In Example 11, the subject matter of any one of Examples 1 to 10 may include, wherein the skill confirmation data includes a uniform resource locator and the second attribute includes content retrieved from the uniform resource locator.

In Example 12, the subject matter of any one of Examples 1 to 11 may include, wherein the second attribute includes a visual indication of the skill confirmation data.

Example 13 includes subject matter (such as a method, means for performing acts, machine readable medium including instructions that when performed by a machine cause the machine to performs acts, or an apparatus to perform) comprising: receiving, from a first entity in a social networking service, an indication that includes an attribute to identify a second entity and a skill for the second entity, the second entity being outside a social graph of the first entity; obtaining a member profile for the second entity by comparing information in the indication received from the first entity to attributes in a set of member profiles; and adding a first attribute to the skill in the member profile, the first attribute including the identity of the first entity.

In Example 14, the subject matter of Example 13 may include, wherein obtaining the member profile includes: determining that the set of member profiles does not include the attribute to identify the second entity; responsive to determining that the set of member profiles does not include the attribute to identify the second entity, communicating, to the second entity, an invitation to create a new member profile; and selecting, in response to creation of the new member profile, the new member profile as the member profile.

In Example 15, the subject matter of any one of Examples 13 to 14 may include, wherein the invitation includes the skill and the skill is added to the new member profile upon creation.

In Example 16, the subject matter of any one of Examples 13 to 15 may include, wherein obtaining the member profile includes: determining that the set of member profiles does not include the attribute to identify the second entity; responsive to the determining that the set of member profiles does not include the attribute to identify the second entity, communicating, to the second entity, an invitation to sign into an existing member profile; and selecting, in response to signing into the existing member profile, the existing member profile as the member profile.

In Example 17, the subject matter of any one of Examples 13 to 16 may include, wherein the invitation includes the skill and the skill is added to the exiting member profile upon signing into the existing member profile.

In Example 18, the subject matter of any one of Examples 13 to 17 may include, wherein the attribute to identify the second entity is added to the existing member profile upon signing into the existing member profile.

In Example 19, the subject matter of any one of Examples 13 to 18 may include, wherein adding the first attribute includes: determining that the member profile does not include the skill; responsive to determining that the member profile does not include the skill, communicating, to the second entity, an invitation to add the skill to the member profile; and responsive to receiving an acceptance of the invitation, adding the skill to the member profile.

In Example 20, the subject matter of any one of Examples 13 to 19 may include, wherein obtaining the member profile includes: selecting the member profile from the set of member profiles; and selecting a skill from a set of skills corresponding to the member profile, and wherein adding the first attribute to the skill does not include communicating with the second entity.

In Example 21, the subject matter of any one of Examples 13 to 20 may include, wherein obtaining the member profile includes: calculating a profile match score based on the comparing the indication to the attributes in the set of member profiles; and selecting the member profile from the set of member profiles based on the profile match score.

In Example 22, the subject matter of any one of Examples 13 to 21 may include, wherein the indication includes skill confirmation data and a second attribute is added to the skill in the member profile, the second attribute including the skill confirmation data.

In Example 23, the subject matter of any one of Examples 13 to 22 may include, wherein the skill confirmation data includes a uniform resource locator and the second attribute includes content retrieved from the uniform resource locator.

In Example 24, the subject matter of any one of Examples 13 to 23 may include, wherein the second attribute includes a visual indication of the skill confirmation data.

Example 25 includes subject matter (such as a CRM) comprising: receiving, from a first entity in a social networking service, an indication that includes an attribute to identify a second entity and a skill for the second entity, the second entity being outside a social graph of the first entity; obtaining a member profile for the second entity by comparing information in the indication received from the first entity to attributes in a set of member profiles; and adding a first attribute to the skill in the member profile, the first attribute including the identity of the first entity.

In Example 26, the subject matter of Example 25 may include, wherein obtaining the member profile includes: determining that the set of member profiles does not include the attribute to identify the second entity; responsive to determining that the set of member profiles does not include the attribute to identify the second entity, communicating, to the second entity, an invitation to create a new member profile; and selecting, in response to creation of the new member profile, the new member profile as the member profile.

In Example 27, the subject matter of any one of Examples 25 to 26 may include, wherein the invitation includes the skill and the skill is added to the new member profile upon creation.

In Example 28, the subject matter of any one of Examples 25 to 27 may include, wherein obtaining the member profile includes: determining that the set of member profiles does not include the attribute to identify the second entity; responsive to the determining that the set of member profiles does not include the attribute to identify the second entity, communicating, to the second entity, an invitation to sign into an existing member profile; and selecting, in response to signing into the existing member profile, the existing member profile as the member profile.

In Example 29, the subject matter of any one of Examples 25 to 28 may include, wherein the invitation includes the skill and the skill is added to the exiting member profile upon signing into the existing member profile.

In Example 30, the subject matter of any one of Examples 25 to 29 may include, wherein the attribute to identify the second entity is added to the existing member profile upon signing into the existing member profile.

In Example 31, the subject matter of any one of Examples 25 to 30 may include, wherein adding the first attribute includes: determining that the member profile does not include the skill; responsive to determining that the member profile does not include the skill, communicating, to the second entity, an invitation to add the skill to the member profile; and responsive to receiving an acceptance of the invitation, adding the skill to the member profile.

In Example 32, the subject matter of any one of Examples 25 to 31 may include, wherein obtaining the member profile includes: selecting the member profile from the set of member profiles; and selecting a skill from a set of skills corresponding to the member profile, and wherein adding the first attribute to the skill does not include communicating with the second entity.

In Example 33, the subject matter of any one of Examples 25 to 32 may include, wherein obtaining the member profile includes: calculating a profile match score based on the comparing the indication to the attributes in the set of member profiles; and selecting the member profile from the set of member profiles based on the profile match score.

In Example 34, the subject matter of any one of Examples 25 to 33 may include, wherein the indication includes skill confirmation data and a second attribute is added to the skill in the member profile, the second attribute including the skill confirmation data.

In Example 35, the subject matter of any one of Examples 25 to 34 may include, wherein the skill confirmation data includes a uniform resource locator and the second attribute includes content retrieved from the uniform resource locator.

In Example 36, the subject matter of any one of Examples 25 to 35 may include, wherein the second attribute includes a visual indication of the skill confirmation data.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A method for third party endorsements, the method comprising electronic operations, which when performed by circuitry of a computing device, causes the computing device to perform the electronic operations including:
receiving, from a first entity in a social networking service, an indication that includes an attribute to identify a second entity and a skill for the second entity, the second entity being outside a first degree of connection of the first entity;
obtaining, by the computing device, a member profile for the second entity by comparing information in the indication received from the first entity to attributes in a set of member profiles;
adding, by the computing device, a first attribute to the skill in the member profile of the second entity, the first attribute including the identity of the first entity;
adding, by the computing device, a second attribute to the skill in the member profile of the second entity, the second attribute including evidence that the second entity completed an activity corresponding with the skill, wherein the second attribute includes a score for the skill obtained by the second entity; and
generating an updated graphical user interface display of the member profile including a visual indication of the first attribute and the second attribute.

2. The method of claim 1, wherein obtaining the member profile includes:
determining that the set of member profiles does not include the attribute to identify the second entity;
responsive to determining that the set of member profiles does not include the attribute to identify the second entity, communicating an invitation to create a new member profile to the second entity; and
selecting, in response to creation of the new member profile, the new member profile as the member profile.

3. The method of claim 1, wherein adding the first attribute includes:
determining that the member profile does not include the skill;
responsive to determining that the member profile does not include the skill, communicating, to the second entity, an invitation to add the skill to the member profile; and
responsive to receiving an acceptance of the invitation, adding the skill to the member profile.

4. The method of claim 1, wherein obtaining the member profile includes:
selecting the member profile from the set of member profiles; and
selecting the skill from a set of skills corresponding to the member profile, and wherein adding the first attribute to the skill does not include communicating with the second entity.

5. A non-transitory machine readable medium that stores instructions which when performed by a machine, cause the machine to perform operations comprising:
receiving, over a network, from a first entity in a social networking service, an indication that includes an attribute to identify a second entity and a skill for the second entity, the second entity being outside a first degree of connection of the first entity;
obtaining a member profile for the second entity by comparing information in the indication received from the first entity to attributes in a set of member profiles;
adding a first attribute to the skill in the member profile, the first attribute including the identity of the first entity;
adding a second attribute to the skill in the member profile, the second attribute including evidence that the second entity completed an activity corresponding with the skill, wherein the second attribute includes a score for the skill obtained by the second entity; and
generating an updated graphical user interface display of the member profile including a visual indication of the first attribute and the second attribute.

6. The machine readable medium of claim 5, wherein obtaining the member profile includes:
determining that the set of member profiles does not include the attribute to identify the second entity;
responsive to determining that the set of member profiles does not include the attribute to identify the second entity, communicating, to the second entity, an invitation to create a new member profile; and
selecting, in response to creation of the new member profile, the new member profile as the member profile.

7. The machine readable medium of claim 6, wherein the invitation includes the skill and the skill is added to the new member profile upon creation.

8. The machine readable medium of claim 5, wherein adding the first attribute includes:
determining that the member profile does not include the skill;
responsive to determining that the member profile does not include the skill, communicating, to the second entity, an invitation to add the skill to the member profile; and
responsive to receiving an acceptance of the invitation, adding the skill to the member profile.

9. The machine readable medium of claim 5, wherein obtaining the member profile includes:
selecting the member profile from the set of member profiles; and
selecting the skill from a set of skills corresponding to the member profile, and wherein adding the first attribute to the skill does not include communicating with the second entity.

10. The machine readable medium of claim 5, wherein obtaining the member profile includes:
calculating a profile match score based on the comparing the indication to the attributes in the set of member profiles; and
selecting the member profile from the set of member profiles based on the profile match score.

11. (canceled)

12. The machine readable medium of claim 5, wherein the evidence that the second entity completed an activity corresponding with the skill includes a uniform resource locator and the second attribute includes content retrieved from the uniform resource locator.

13. The machine readable medium of claim 5, wherein the second attribute includes a visual indication of evidence that the second entity completed an activity corresponding with the skill.

14. A system comprising:
at least one processor;
a memory; and
a set of instructions operable on the at least one processor to:
receive, from a first entity in a social networking service, an indication that includes an attribute to identify a second entity and a skill for the second entity, the second entity being outside a first degree of connection of the first entity;
obtain a member profile for the second entity by comparing information in the indication received from the first entity to attributes in a set of member profiles;
add a first attribute to the skill in the member profile, the first attribute including the identity of the first entity;
add a second attribute to the skill in the member profile, the second attribute including evidence that the second entity completed an activity corresponding with the skill, wherein the second attribute includes a score for the skill obtained by the second entity; and
generate an updated graphical user interface display of the member profile including a visual indication of the first attribute and the second attribute.

15. The system of claim 14, wherein the set of instructions to obtain the member profile includes instructions to:
determine that the set of member profiles does not include the attribute to identify the second entity;
responsive to determining that the set of member profiles does not include the attribute to identify the second entity, communicating, to the second entity, an invitation to create a new member profile; and
select, in response to creation of the new member profile, the new member profile as the member profile.

16. The system of claim 15, wherein the invitation includes the skill and the skill is added to the new member profile upon creation.

17. The system of claim 14, wherein the set of instructions to add the first attribute includes instructions to:
determine that the set of member profiles does not include the skill;
responsive to determining that the member profile does not include the skill, communicating, to the second entity, an invitation to add the skill to the member profile; and
responsive to receiving an acceptance of the invitation, add the skill to the member profile.

18. The system of claim 14, wherein the set of instructions to obtain the member profile includes instructions to:
select the member profile from the set of member profiles; and
select the skill from a set of skills corresponding to the member profile, and wherein adding the first attribute to the skill does not include communicating with the second entity.

19. The system of claim 14, wherein the set of instructions to obtain the member profile includes instructions to:
calculate a profile match score based on the comparing the indication to the attributes in the set of member profiles; and
select the member profile from the set of member profiles based on the profile match score.

20. (canceled)
